(19) United States
(12) Patent Application Publication
(10) Pub. No.: US 2004/0152003 A1
(43) Pub. Date: Aug. 5, 2004

(54) Developing agent

(75) Inventors: Shuitsu Sato, Tokyo (JP); Takashi Urabe, Shizuoka-ken (JP); Yasuhito Noda, Shizuoka-ken (JP); Takahito Kabai, Shizuoka-ken (JP); Yuichi Hori, Shizuoka-ken (JP)

Correspondence Address: FOLEY AND LARDNER, SUITE 500, 3000 K STREET NW, WASHINGTON, DC, 20007, US

(73) Assignee: Toshiba Tec Kabushiki Kaisha

(21) Appl. No.: 10/358,235

(22) Filed: Feb. 5, 2003

(51) Int. Cl. G03G 9/087

(52) U.S. Cl. 430/108.4; 430/109.4; 430/111.4

(57) ABSTRACT

A developing agent comprising a binder resin containing a crystalline resin having a crystallinity of 10 to 50%, and the temperature at the DSC heat absorption peak of the developing agent in the heating step differs from the temperature at the DSC heat generation peak of the developing agent in the cooling step.

### BACKGROUND OF THE INVENTION

The present invention relates to a developing agent for developing an electrostatic charge image or a magnetic latent image in, for example, an electrophotographic method, an electrostatic printing method, or a magnetic recording method, particularly, to a developing agent adapted for an image forming apparatus of a heat fixing system.

As a measure taken in recent years for energy saving, use is made of a heating roller having a thin mandrel. In this case, the amount of heat that can be held by the heating roller itself, i.e., the heat capacity of the heating roller, is decreased so as to shorten the time required for heating the heating roller to a prescribed temperature. It should be noted in this connection that, since the heating roller has a small heat capacity, the temperature drop at the surface of the heating roller is made prominent when the transfer material such as a paper sheet passes over the surface of the heating roller.

On the other hand, there is an idea in respect of the improvement on the side of the toner that an offset inhibitor is supplied from the toner in place of using an apparatus for supplying a silicone oil. For example, it is proposed in Jpn. Pat. Appln. KOKOKU Publication No. 52-3304 that a releasing agent such as a low molecular weight polyethylene or a low molecular weight polypropylene is added to the toner.

The waxes used for preparing the developing agent are effective for improving the resistance of the toner to the offset phenomenon taking place under low temperatures or under high temperatures and for improving the fixing properties of the developing agent under low temperatures. However, the waxes, which certainly permit improving the resistance to the offset phenomenon and the fixing properties, cause the resistance of the developing agent to the blocking to be come poor. Also, the waxes cause the developing properties of the developing agent to deteriorated if the developing agent is exposed to a high temperature because of the temperature elevation within the image forming apparatus. Further, the waxes are subjected to the blooming if the developing agent is left to stand for a long time, so as to degrade the developing properties of the developing agent.

As described above, the conventional toner cannot satisfy all of the resistance to the offset phenomenon, the fixing properties, the resistance to the blocking, and the storage characteristics, and some problems remain unsolved.

### BRIEF SUMMARY OF THE INVENTION

An object of the present invention is to provide a developing agent, which is satisfactory in any of the resistance to the offset phenomenon, the fixing properties, the resistance to blocking and the storage characteristics, and which can be used suitably in an image forming apparatus of a heat fixing system without bringing about problems such as smear, sticking, stains of the parts of the image forming apparatus, and winding of the transfer material.

According to a first aspect of the present invention, there is provided a developing agent comprising a binder resin containing a crystalline resin having a crystallinity of 10 to 50% and a coloring agent, wherein, in the DSC curve measured by a differential thermal analysis apparatus, the temperature at the DSC heat absorption peak in the heating step differs from the temperature at the DSC heat generation peak in the cooling step.

According to a second aspect of the present invention, there is provided a developing agent comprising a binder resin containing a crystalline resin and a coloring agent, wherein, in the DSC curve measured by a differential thermal analysis apparatus, the temperature at the DSC heat absorption peak in the heating step falls within the range of 100° C. to 135° C., the temperature at the DSC heat generation peak in the cooling step falls within the range of 70° C. to 120° C., and the ratio of the heat amount of the DSC heat absorption peak to the DSC heat generation peak falls within the range of 1 to 2.

According to a third aspect of the present invention, there is provided a developing agent comprising a binder resin containing a crystalline resin and a coloring agent, wherein, in the DSC curve measured by a differential thermal analysis apparatus, the rising temperature of the DSC heat absorption peak in the heating step falls within the range of the temperature at the DSC heat absorption peak to the temperature lower by 30° C. than the temperature at the DSC heat absorption peak, and the rising temperature of the DSC heat generation peak in the cooling step falls within the range of the temperature at the DSC heat generation peak to the temperature higher by 20° C. than the temperature at the DSC heat generation peak.

Further, according to a fourth aspect of the present invention, there is provided a developing agent comprising a binder resin containing a crystalline resin and a coloring agent, wherein, in the DSC curve measured by a differential thermal analysis apparatus, the relationship given below between the temperature y of the DSC heat generation peak in the cooling step and the cooling rate x is satisfied:

y=−a×Ln(x)+b

0.5≦a≦10, 60≦b≦100

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a graph exemplifying a DSC curve for the developing agent of the present invention;

FIG. 2 is a graph showing the relationship between the melt viscosity and the temperature in respect of an example of a crystalline polyester resin and an example of an amorphous polyester resin;

FIG. 3 is a graph showing a range defined by the logarithmic value of the cooling rate x (C/min) and the heat generation peak y (° C.); and

FIG. 4 exemplifies the construction of a fixing apparatus to which the developing agent of the present invention can be applied.

### DETAILED DESCRIPTION OF THE INVENTION

As a result of extensive research conducted in an attempt to overcome the above-noted problems inherent in the prior art, the present inventors have found that it is possible to obtain a developing agent excellent in the resistance to the offset phenomenon, the fixing properties, the resistance to blocking and the storage characteristics by using a crystalline substance (linear compound) exhibiting specified thermal characteristics so as to arrive at the present invention.

The developing agent according a first aspect of the present invention comprises a binder resin containing a crystalline resin and a coloring agent and is featured in that the crystalline resin used has a crystallinity of 10 to 50%, and that, in the DSC curve measured by a differential thermal analysis apparatus using a differential scanning calorimeter, the temperature at the DSC heat absorption peak in the heating step differs from the temperature at the DSC heat generation peak in the cooling step.

According to the present invention, it is possible to obtain excellent resistance to the offset phenomenon so as to widen the temperature range within which the fixing can be performed. As a result, it is possible to obtain excellent fixing properties and to increase the fixing rate. It is also possible to improve the resistance to the blocking and the storage characteristics. When it comes to the resistance to the offset phenomenon, the viscosity of the developing agent is rapidly lowered immediately after the heating in the fixing device so as to improve the fixing properties of the toner to the paper sheet so as to improve the resistance to the offset phenomenon at low temperatures. Further, after the fixing, the viscosity of the toner is gradually increased until the toner is cooled to low temperatures so as to alleviate the adhesion of the toner to the fixing roller, with the result that the resistance to the offset phenomenon at high temperatures is improved.

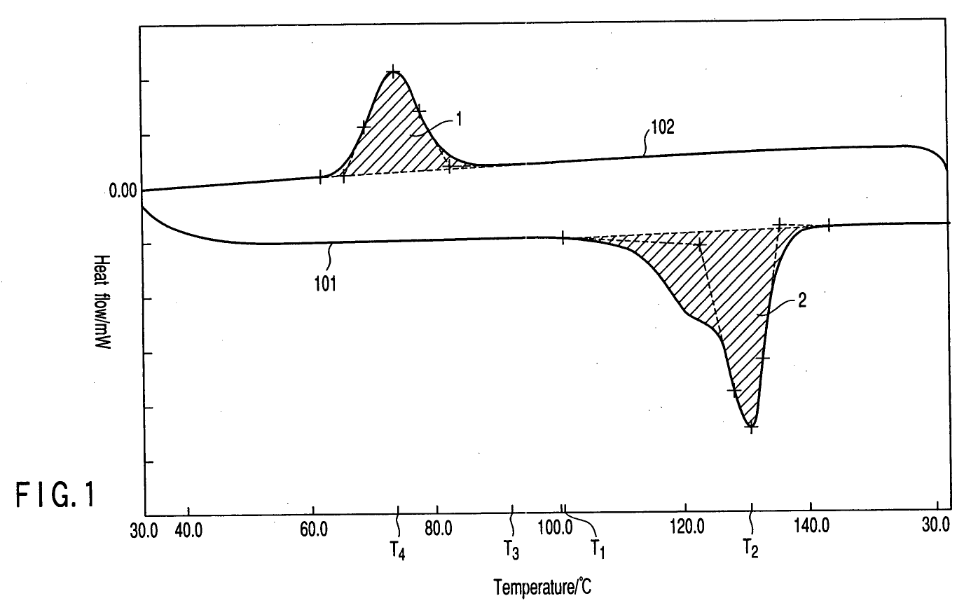

FIG. 1 exemplifies the DSC curve obtained by measuring the developing agent of the present invention by using a differential thermal analysis apparatus. Curve 101 in FIG. 1 denotes the change in the heat amount in the cooling step, and curve 102 denotes the change in the heat amount in the heating step.

In the measurement by the differential thermal analysis apparatus, the sample is left to stand at 0° C. for one minute, followed by heating the sample to 200° C. at a heating rate of 10° C./min, thereby the temperature denoting the heat absorption peak measured in this process can be obtained. Then, the sample is left to stand at 200° C. for one minute, followed by cooling the sample at a cooling rate of 10° C./min, thereby the temperature denoting the maximum heat generation peak measured in this process can be obtained. It is possible to use, for example, a DSC-7 manufactured by Perkin Elmer Inc. as the differential thermal analysis apparatus.

As denoted by curve 101, the heat absorption is started when the sample is heated to temperature T1, which is called the rising temperature of the heat absorption, in the heating step, and the heat absorption amount is increased to reach the maximum level at temperature T2 at the heat absorption peak, which is 130° C. If the sample is further heated, the heat absorption amount is rapidly lowered and, then, the heat amount is made substantially constant.

On the other hand, the heat generation is started when the sample is cooled to temperature T₃, which is called the rising temperature of the heat generation, in the cooling step, and the heat generation amount is increased to reach the maximum level at temperature T₄ at the heat generation peak, which is 73.8° C. If the sample is further cooled, the heat generation amount is rapidly lowered and, then, the heat amount is made substantially constant.

The behavior of the DSC curve of the developing agent is dependent on the thermal characteristics of the crystalline resin used, though it is possible for a sufficient peak to fail to be obtained in the case where the addition amount of the crystalline resin is unduly small.

It is possible for the temperature at the DSC heat generation peak to be affected by the thermal characteristics of the crystalline resin used such that the temperature at the DSC heat generation peak is shifted to temperatures lower than the temperature at the DSC heat absorption peak.

The crystalline resin used in the present invention has a crystallinity of, for example, about 10 to 50%, preferably 30 to 40%, and has a temperature range, within which the viscosity is rapidly decreased relative to the temperature elevation, narrower than that for the amorphous resin. If the crystallinity of the crystalline resin is lower than 10%, a longer time tends to be required to melt the resin, with the result that the effect of improving the fixing properties tends to be lowered. On the other hand, if the crystallinity is higher than 50%, a longer time tends to be required for the recrystallization. Since the resin is not recrystallized unless the resin after the melting by heating is lowered to a considerably low temperature, the phenomenon that the overlapped images are offset tends to be generated, with the result that the image quality tends to be impaired. Incidentally, the crystallinity can be obtained by the magnitude of the diffraction peak intensity obtained by the X-ray diffraction apparatus.

In the present invention, a crystalline polyester resin is used preferably as such a crystalline resin.

The difference between the crystalline characteristics and the amorphous characteristics of the polyester resins will now be described by using a graph showing the melting characteristics of the polyester resins.

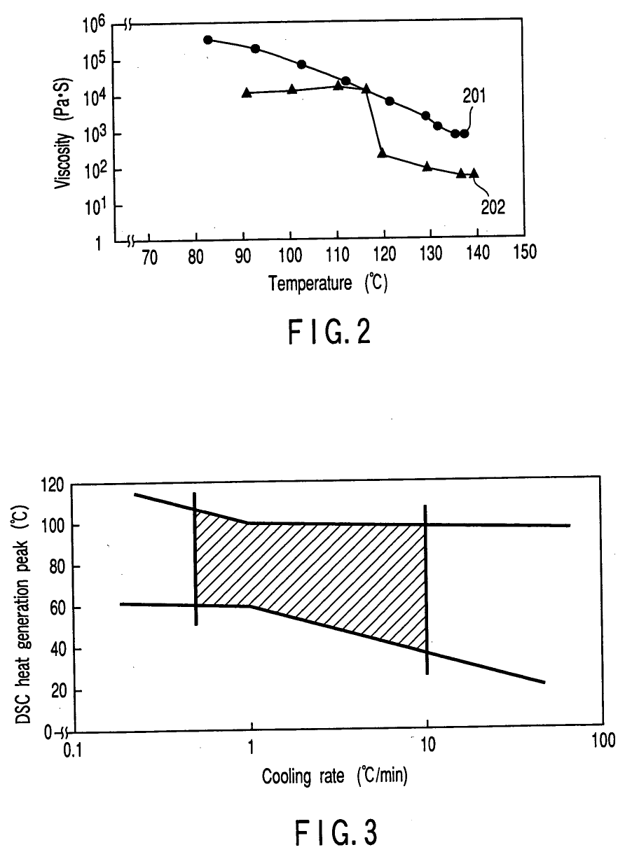

FIG. 2 is a graph showing the relationship between the melt viscosity and the temperature in respect of an example of a polyester resin exhibiting crystalline characteristics and having a softening point of 120° C. and an example of a polyester resin exhibiting amorphous characteristics and having a softening point of 105° C.

Curve 201 shown in the graph of FIG. 2 represents a polyester resin having amorphous characteristics. As apparent from curve 201, the viscosity of the polyester resin exhibiting the amorphous characteristics is moderately decreased relative to the temperature elevation over a wide temperature range. On the other hand, curve 202 shown in the graph represents a polyester resin exhibiting crystalline characteristics. As apparent from curve 202, the polyester resin exhibiting crystalline characteristics has a narrow temperature range within which the viscosity is rapidly lowered relative to the temperature elevation.

The developing agent according to a second aspect of the present invention comprises a binder resin containing a crystalline resin and a coloring agent. In the developing agent according to the second aspect of the present invention, the temperature at the DSC heat absorption peak at the heating step falls within the range of 100° C. to 135° C., the temperature at the DSC heat generation peak at the cooling step falls within the range of 7° C. to 12° C., and the ratio of the heat amount of the heat absorption peak to the heat generation peak falls within the range of 1 to 2.

Incidentally, the heat generation amount represents the area of the shaded region 1 shown in FIG. 1, and the heat absorption amount represents the shaped region 2 shown in FIG. 1.

The heating temperature of the fixing device, which can be applied to the developing agent of the present invention, falls within the range of about 120° C. to about 230° C., preferably about 120° C. to about 190° C. If the temperature at the DSC heat absorption peak in the heating step falls within the range of 100° C. to 135° C., the viscosity of the crystalline resin contained in the binder resin, which is melted by the heating temperature, can be more lowered so as to facilitate the bonding of the developing agent to the transfer material. Also, if the temperature at the DSC heat generation peak in the cooling step falls within the range of 70° C. to 120° C., the crystalline resin contained the binder resin, which is solidified by the cooling when the transfer material heated within the fixing device is transferred out of the fixing device so as to be cooled, is solidified more rapidly so as to achieve a satisfactory fixing performance.

The developing agent according to a third aspect of the present invention comprises a binder resin containing a crystalline resin and a coloring agent. In the developing agent according to the third aspect of the present invention, the rising temperature T₁ of the DSC heat absorption peak in the heating step falls within the range of temperature T₂ at the DSC heat absorption peak to the temperature lower by 30° C. than temperature T₂ at the DSC heat absorption peak, and the rising temperature T₃ of the DSC heat generation peak in the cooling step falls within the range of temperature T₄ at the DSC heat generation peak to the temperature higher by 20° C. than temperature T₄ at the DSC heat generation peak.

In the developing agent according to the third aspect of the present invention, it is desirable for the difference between the temperature at the DSC heat absorption peak and the rising temperature of the DSC heat absorption peak to be small so as to permit the heat absorption behavior to be performed rapidly. In this case, the viscosity of the crystalline resin contained in the binder resin can be rapidly lowered in the heating step, and the crystalline resin can be solidified rapidly in the cooling step. As a result, the toner image can be fixed satisfactorily.

Further, the developing agent according to a fourth aspect of the present invention comprises a binder resin containing a crystalline resin and a coloring agent. In the developing agent according to the fourth aspect of the present invention, the relationship given below between the temperature y (° C.) at the DSC heat generation peak in the cooling step and the cooling rate x (° C./min) is satisfied:

y=−a×Ln(x)+b

0.5≦a≦10, 60≦b≦100

The temperature at the DSC heat generation peak is changed depending on the cooling rate.

Among the temperature at the heat absorption peak in the heating process and the temperature at the heat generation peak in the cooling process (recrystallizing process) in the DSC curve obtained by the differential thermal analysis, the temperature at the heat generation peak is changed depending on the cooling rate.

It should be noted that the temperature at the heat generation peak is lowered with increase in the cooling rate. In general, the heating time of the developing agent within the fixing device is not longer than about one second, and the fixing temperature is set at, for example, 160° C., though the actual heating time and the fixing temperature are somewhat deviated from these values depending on the process conditions in the fixing process of the image forming apparatus. The recording paper sheet having the toner image fixed thereto is discharged from the fixing device immediately after the fixing step. As a result, the developing agent put under the high temperature environment of 160° C. is exposed to an environment of, for example, 25° C. In other words, the developing agent is rapidly cooled. Where the developing agent is cooled at such a high cooling rate, it is possible for the temperature at the heat generation peak of the crystalline resin contained in the toner on the recording paper sheet to be rendered lower than the temperature of the paper sheet discharged out of the fixing device.

In this case, the crystalline resin contained in the toner immediately after the discharge of the recording paper sheet out of the fixing device is not crystallized and is held viscous. As a result, when the discharged recording paper sheets are stacked one upon the other, it is possible for the viscous crystalline resin to be attached to the back surface of the adjacent recording paper sheet so as to bring about the phenomenon of the offset of the toner. Also, where the crystalline resin is poor in the releasability from the fixing roller, it is possible for the crystalline resin to be wound about the fixing roller or for the toner to be attached to the surface of the fixing roller so as to bring about the offset phenomenon. As a result, the toner image is stained, and the life of the cleaning mechanism of the fixing roller is shortened in some cases.

In order to overcome the inconveniences described above, it is desirable to use the developing agent meeting the formula given above.

The formula given above denotes that a linear relationship is established between the logarithmic value of the cooling rate x (° C./min) and the temperature y (° C.) at the heat generation peak in the DSC measurement.

According to the fourth aspect of the present invention, the gradient “a” and the intercept “b” of the straight line are set to fall within the ranges of 0.5≦a≦10 and 60≦b≦100, respectively, so as to make it possible to prevent, for example, the offset of the toner, the winding of the recording paper sheet, the offset phenomenon, and the shortening of the life of the cleaning mechanism.

FIG. 3 is a graph showing the ranges of the logarithmic values of the cooling rate x (° C./min) and the temperatures y (° C.) of the heat generation peak represented by the formula given previously.

The range of the intercept “b” is important. Where the value of “b” is smaller than 60° C., the toner, particularly, the crystalline resin contained in the toner, is considered not to be crystallized so as to be held viscous. Particularly, where the temperature of the recording paper sheets stacked one upon the other immediately after the discharge from the fixing device is higher than 60° C., it is possible for the offset to take place. On the other hand, where the value of “b” is larger than 100° C., the toner is not rendered sufficiently viscous upon receipt of heat from the fixing device, with the result that the fixing strength is lowered.

The gradient “a” denotes the degree of recrystallization of the molten crystalline resin contained in the toner. If the value of the gradient “a” is small, the molten crystalline resin tends to be recrystallized easily so as to rapidly lower the viscosity. On the other hand, if the value of the gradient “a” is large, the molten crystalline resin is unlikely to be recrystallized and, thus, the viscosity of the toner is lowered moderately. Where the gradient “a” is smaller than 0.5, the period during which the toner is held viscous is excessively short, with the result that the fixing strength tends to be lowered. By contraries, where the gradient “a” is larger than 10, the period during which the toner is held viscous is excessively long, with the result that the offset of the toner tends to be generated.

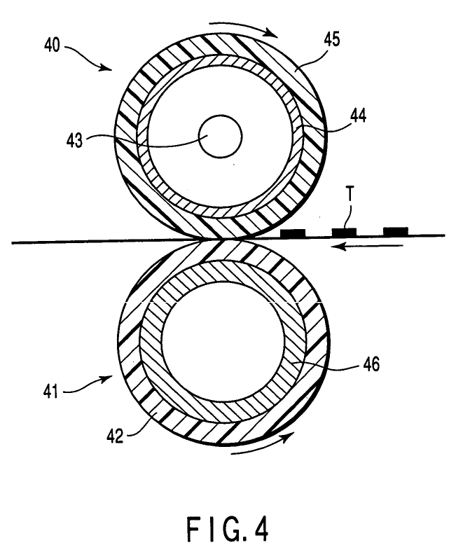

FIG. 4 exemplifies the construction of a fixing device to which the developing agent of the present invention can be applied.

As shown in the drawing, the fixing device comprises a heating roller 40 and a pressurizing roller 41 abutting against the heating roller 40. The heating roller 40 includes a core 44, a covering layer 45 covering the outer surface of the core 44 and made of a fluorine-series resin, and a heating body 43 arranged inside the core 44. On the other hand, the pressurizing roller 41 includes a core 46 and, for example, a silicone rubber layer 42 covering the outer surface of the core 46. The pressurizing roller 41 of the particular construction is allowed to abut against the heating roller 40 such that a prescribed load is applied to the heating roller 40.

The core 44 of the heating roller 40 is made of, for example, a metal selected the group consisting of aluminum, iron, copper and an alloy thereof, and has an inner diameter of, for example, 10 to 50 mm. The thickness of the core 44, which is determined in view of the balance between the thinning required for the energy saving and the mechanical strength, is, for example, about 0.1 to 2 mm. In order to obtain a mechanical strength substantially equal to that of the core made of iron and having a thickness of 0.57 mm, it is necessary for the core 44 to have a thickness of 0.8 mm in the case of using aluminum for forming the core 44.

The fluorine-based resins used for forming the covering layer 45 of the heating roller 40 include, for example, polytetrafluoro ethylene, PTFE, and tetrafluoro ethylene-perfluoroalkyl vinyl ether copolymer, PFA. The thickness of the covering layer 45 falls within a range of between 50 μm and 1,000 μm.

It is possible to use, for example, an electromagnetic induction coil or a halogen heater as a suitable means of the heat source (heating body) 43. The heat source is not limited to a single heat source. It is also possible to arrange a plurality of divided sections of the heat source within the core 44 such that the heating region can be changed in accordance with the width of the transfer material passing through the heating roller 40.

The pressurizing roller 41 comprises the core 46 and the covering layer 42 covering the outer surface of the core 46 and made of, for example, a silicone rubber. The core 46 is made of a metal such as aluminum or iron or an alloy thereof. The thickness of the covering layer 42 is set at, for example, 1 to 30 mm. The Asker C hardness of the silicone rubber constituting the covering layer 42 is, for example, 35 to 90. It is possible to use a silicone sponge rubber as the silicone rubber.

The abutting load (total load) between the heating roller 40 and the pressurizing roller 41 falls within a range of, for example, between 300 N and 900 N. The abutting load is defined in view of the mechanical strength of the pressurizing roller 41 which is determined by the thickness of the core 46. When it comes to, for example, a pressurizing roller including a core made of iron and having a thickness of 0.3 mm, it is desirable for the abutting load to be not larger than 500 N.

If the transfer material having a developing agent image, which is developed by using the developing agent of the present invention, transferred thereonto is supplied to the fixing device of the construction described above, the developing agent image is heated, melted and pressurized so as to permit the developing agent image to be fixed to the transfer material.

Incidentally, in view of the resistance to the offset phenomenon and the fixing properties, the nip width of the fixing device is set at, for example, 4 mm to 8 mm.

The binder resin used for preparing the developing agent of the present invention comprises the crystalline resin referred to above and an amorphous binder resin.

It is desirable for the amorphous binder resin and the crystalline resin to be present independent of each other. The crystalline resin is sharply dissolved, and the crystalline resin under a molten state performs the function of dissolving the amorphous resin, with the result that the melt viscosity of the entire toner is lowered so as to improve the fixing properties. Also, since the amorphous binder resin and the crystalline resin are present independent of each other, it is possible to suppress the decrease of the elasticity modulus on the high temperature side, with the result that the resistance to the offset phenomenon is not impaired.

The amount of the amorphous binder resin based on the entire binder resin should fall preferably within the range of 70% by weight to 98% by weight and, more preferably, 80% by weight to 95% by weight. On the other hand, the amount of the crystalline resin based on the entire binder resin should fall preferably within the range of 2% by weight to 30% by weight and, more preferably, 5% by weight to 20% by weight.

If the amount of the amorphous resin contained in the binder resin exceeds 98% by weight, the fixing properties under low temperatures and the resistance to the offset phenomenon tend to be deteriorated though the environmental stability is satisfactory in this case. On the other hand, if the amount of the amorphous resin noted above is smaller than 70% by weight, the stains of the part, the storage properties and the resistance to the blocking tend to be deteriorated, though the fixing properties under low temperatures are satisfactory.

If the amount of the crystalline resin contained in the binder resin exceeds 30% by weight, the sticking, the storing properties and the resistance to the blocking tend to deteriorate, though the fixing properties at low temperatures are satisfactory. Conversely, if the amount of the crystalline resin noted above is smaller than 2% by weight, the fixing properties under low temperatures and the resistance to the offset phenomenon tend to deteriorate.

The crystalline resin used in the present invention can be obtained by using a monomer including a carboxylic acid component consisting of a polyhydric carboxylic acid compound having a valency of two or more and another monomer including an alcohol component consisting of a polyhydric alcohol compound having a valency of two or more. The acid components referred to above include, for example, fumaric acid, maleic acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, a succinic acid in which is substituted an alkyl group having 1 to 20 carbon atoms or an alkenyl group having 2 to 20 carbon atoms such as dodecyl succinic acid and octyl succinic acid, an anhydride of these acids, and a derivative of these acids such as an alkyl ester. On the other hand, the alcohol components used for preparing the crystalline resin contained in the developing agent of the present invention include, for example, aliphatic polyols such as ethylene glycol, propylene glycol, 1,4-butane diol, 1,3-butane diol, 1,5-pentane diol, 1,6-hexane diol, neopentane glycol, glycerin, trimethylol ethane, trimethylol propane, and pentaerythritol; alicyclic polyols such as 1,4-cyclohexane diol, and 1,4-cyclohexane dimethanol; and ethylene oxide or propylene oxide adducts such as bisphenol-A. Particularly, it is desirable to use a crystalline compound, which is generally waxy and which can be obtained by the polycondensation between an alcohol component having an alkyl group or an alkenyl group having at least 16 carbon atoms and containing at least 80 mol % of diols having 2 to 6 carbon atoms and a carboxylic acid component containing at least 80 mol % of fumaric acid. It is desirable for the generally wax-like crystalline compound thus obtained to have a softening point falling within the range of 110° C. to 150° C. and a glass transition point falling within the range of 100° C. to 140° C., the difference between the melting point and the glass transition point falling within the range of 0.1° C. to 10° C. One or more kinds of crystalline resins can be used in the developing agent according to the present invention.

The amorphous binder resins used in the present invention include, for example, homopolymers of styrene and substituted compounds thereof such as polystyrene, poly-p-chlorostyrene and polyvinyl toluene; styrene-based copolymers such as styrene-p-chlorostyrene copolymer, styrene-vinyl toluene copolymer, styrene-vinyl naphthalene copolymer, styrene-acrylic acid ester copolymer, styrene-methacrylic acid ester copolymer, styrene-α-methyl chloromethacrylate copolymer, styrene-acrylonitrile copolymer, styrene-vinyl methyl ether copolymer, styrene-vinyl ethyl ether copolymer, styrene-vinyl methyl ketone copolymer, styrene-butadiene copolymer, styrene-isoprene copolymer, and styrene-acrylonitrile-indene copolymer; as well as polyvinyl chloride, a phenolic resin, a naturally denatured phenolic resin, a natural resin modified maleic acid resin, an acrylic resin, a methacrylic resin, polyvinyl acetate, a silicone resin, a polyester resin, polyurethane, a polyamide resin, a furan resin, an epoxy resin, a xylene resin, polyvinyl butyral, a terpene resin, a cumarone indene resin, and a petroleum series resin. Among these resins, it is desirable to use a styrene-based copolymer or a polyester resin as the binder resin.

In the present invention, it is desirable to use at least two kinds of waxes including a second wax having a melting point lower by at least 10° C. than the melting point of the crystalline resin and a first resin having a melting point higher by at least 10° C. than the melting point of the crystalline resin. The waxes meeting these requirements include, for example, an aliphatic hydrocarbon series waxes such as a low molecular weight polyethylene, a low molecular weight polypropylene, an olefin copolymer, a polyolefin wax, a microcrystalline wax, a paraffin wax, and a Fischer-Tropsch wax; oxides of an aliphatic hydrocarbon series waxes or block copolymers thereof such as an oxidized polyethylene wax; plant waxes such as candelilla wax, carnauba wax, Japan wax, jojoba wax, and rice wax; animal waxes such as beeswax, lanolin, and whale wax; mineral waxes such as ozokerite, ceresin and petrolatum; waxes containing fatty acid esters as the main component such as montanic acid ester wax and castor wax; and waxes prepared by deoxidizing partially or entirely the fatty acid ester such as a deoxidized carnauba wax.

The first wax referred to above includes, for example, waxes having a melting point not lower than 120° C. such as a high density low molecular weight polyethylene having a melting point of 124° C. to 133° C. and a low molecular weight polypropylene having a melting point of 145° C. to 164° C.

On the other hand, the second wax referred to above includes the waxes having a melting point not higher than 130° C. The specific waxes meeting this requirement include, for example, plant waxes and animal waxes such as candelilla wax having a melting point of 71° C., carnauba wax having a melting point of 83° C., rice wax having a melting point of 79° C., jojoba wax having a melting point of 95° C., white wax having a melting point of 53° C., and beeswax wax having a melting point of 64° C.; aliphatic hydrocarbon series waxes such as a paraffin wax having a melting point of 80° C. to 107° C.; as well as a long chain ester wax having a melting point of 90° C. to 95° C., a fatty acid ester wax having a melting point of 60° C. to 82° C., a wax having an acidic atomic group and having a melting point of 73° C., a metal salt of a fatty acid such as zinc stearate having a melting point of 123° C., a montan wax having a melting point of 79° C. to 89° C., a montanic acid ester wax having a melting point of 56° C. to 92° C., and a low density low molecular weight polyethylene having a melting point of 103° C. to 124° C.

It is possible to add the first wax in the kneading step of the binder resin, the coloring agent, etc. Alternatively, it is possible to add the first wax in the polymerizing step of the amorphous binder resin. It is desirable for the addition amount of the first wax to fall within the range of 0.1 to 8 parts by weight relative to 100 parts by weight of the resin solid component in the solution because, in this case, the first wax can be dispersed more satisfactorily.

It is possible to add the second wax in the kneading step of the binder resin, the coloring agent, etc. Alternatively, the second wax can be added in the polymerizing step of the crystalline resin. It is desirable for the addition amount of the second wax to fall within the range of 0.1 to 8 parts by weight relative to 100 parts by weight of the resin solid component in the solution because, in this case, the second wax can be dispersed more satisfactorily.

The waxes can be used in an optional combination respectively. It is possible for the wax having a low melting point to exhibit a plasticizing function so as to contribute to the improvement in the fixing properties of the toner under low temperatures and to further enhance the effect produced by the crystalline resin. On the other hand, it is possible for the wax having a high melting point to produce the effect of improving the releasing function so as to contribute to the improvement in the resistance to the offset phenomenon under high temperatures.

The coloring agent used in the present invention includes, for example, carbon black, and organic or inorganic pigments and dyes. The carbon black used in the present invention includes, for example, acetylene black, furnace black, thermal black, channel black and Ketchen black. The pigments and dyes used in the present invention include, for example, fast yellow G, benzidine yellow, indo fast orange, irugasine red, carmine FB, permanent bordeaux FRR, pigment orange R, lithol red 2G, lake red C, rhodamine FB, rhodamine B lake, phthalocyanine blue, pigment blue, brilliant green B, phthalocyanine green and quinacridone. These pigments and dyes can be used singly or in the form of a mixture of at least two of these pigments and dyes.

It is possible to mix a charge control agent for controlling the frictional charge with the developing agent of the present invention.

Used as the charge control agent is, for example, a metal-containing azo compound. Specifically, it is desirable to use a complex or a complex salt in which iron, cobalt or chromium constitutes the metal element. It is also desirable to use a mixture of such a complex and a complex salt.

For example, used preferably as a charge control agent is a metal-containing salicylic acid derivative compound, i.e., a complex or a complex salt in which zirconium, zinc, chromium or boron constitutes the metal element, or a mixture of the complex and the complex salt.

Also, in the developing agent of the present invention, it is possible to add inorganic particles in an amount of 0.2 to 3% by weight based on the total weight of the toner particles in order to impart fluidity and the charging properties to the toner particles containing a crystalline binder resin and the coloring agent.

The inorganic particles used in the present invention include, for example, particles of silica, titania, alumina, strontium titanate and tin oxide. These inorganic particles can be used singly or in the form of a mixture of at least two of these inorganic particles. In view of the improvement in the environmental stability, it is desirable to use the inorganic particles subjected to the surface treatment with a hydrophobic agent.

Also, in order to improve the cleaning performance, it is desirable to add resin fin particles having a particle diameter not larger than, for example, 1 μm to the toner particles in addition to the inorganic oxides.

The developing agent of the present invention can be used as a developing agent of a two-component system prepared by adding a carrier to the toner.

The ferrite carrier can be used desirably in the present invention. The carrier particle of the ferrite carrier comprises a core particle represented by (MO)ₓ(Fe₂O₃)_{y}, X/Y<1.0, where M represents a single metal or a plurality of metals selected from the group consisting of Li, Mg, Mn, Fe(II), Co, Ni, Cu, Zn, Cd, Sr and Ba, and a silicone resin layer covering the surface of the carrier particle. The resistance of the carrier particle under the 250V/2.0 mm gap falls within the range of, for example, 1×10¹⁰ Ω to 3×10¹² Ω, and the particle diameter of the carrier particle falls within the range of about 60 μm to 30 μm.

The present invention will now be described more in detail with reference to the following Examples of the present invention. In the following Examples, the expression “parts” represents “parts by weight”.

### EXAMPLES

Prepared was a fixing device constructed as shown in FIG. 4. To be more specific, prepared was a fixing device comprising a heating roller including a PFA tube layer formed on the surface and a having a diameter of 40 mm and a pressurizing roller abutting against the heating roller with an abutting load of 700 N, having a silicone rubber layer formed on the surface and having a diameter of 30 mm. The temperature of the fixing device was controlled at 160° C. by a thermistor connected to the heating roller. The pressurizing force was finely controlled to obtain a nip width of 6 mm. Also, the fixing rate was set at 200 mm/sec.

### Examples 1 to 9

Composition of Toner Particle Material:

Binder resin (mixture of a polyester resin having a softening point of 100° C. and another polyester resin having a softening point of 150° C., which were mixed at a mixing ratio of 6:4) . . . 100 parts

Crystalline polyesters A to I having thermal characteristics shown in Tables 1-1 and 1-2 . . . 5 parts

Coloring agent (copper phthalocyanine blue pigment) . . . 6 parts

Charge control agent (organometallic compound of zirconium salt) . . . 1 part

First wax (polypropylene wax having a melting point of 150° C.) . . . 2 parts

Second wax (rice wax having a melting point of 79° C.) . . . 2 parts

TABLE 1-1

| | | Temperature | Temperature | | | Heat absorption |
|---|---|---|---|---|---|---|
| | | at DSC heat | at DSC heat | Heat | Heat | amount/heat |
| | Crystalline | absorption | generation | absorption | generation | generation |
| | polyester | peak (° C.) | peak (° C.) | amount | amount | amount |
| Example 1 | A | 100 | 73 | 1.4 | 1.1 | 1.27 |
| Example 2 | B | 109 | 73 | 2.1 | 1.3 | 1.62 |
| Example 3 | C | 124 | 106 | 0.9 | 0.53 | 1.70 |
| Example 4 | D | 125 | 115 | 0.85 | 0.47 | 1.81 |
| Example 5 | E | 130 | 74 | 0.24 | 0.23 | 1.04 |
| Example 6 | F | 90 | 75 | 2 | 0.95 | 2.11 |
| Example 7 | G | 140 | 128 | 0.31 | 0.24 | 1.29 |
| Example 8 | H | 100 | 60 | 1.5 | 1 | 1.5 |
| Example 9 | I | 160 | 130 | 0.31 | 0.13 | 2.38 |

TABLE 1-2

| | Rising | Rising | | | |
|---|---|---|---|---|---|
| | temperature | temperature | | | |
| | of DSC heat | of DSC heat | | | |
| | absorption | generation | | | |
| | peak (° C.) | peak (° C.) | Crystallinity | a | b (° C.) |
| Example 1 | 86 | 77 | 30 | 6 | 85 |
| Example 2 | 96 | 75 | 20 | 1 | 65 |
| Example 3 | 113 | 113 | 10 | 10 | 100 |
| Example 4 | 115 | 120 | 50 | 0.5 | 60 |
| Example 5 | 123 | 77 | 40 | 7 | 61 |
| Example 6 | 76 | 85 | 60 | 12 | 50 |
| Example 7 | 115 | 143 | 5 | 0.2 | 110 |
| Example 8 | 90 | 83 | 3 | 0.2 | 50 |
| Example 9 | 120 | 144 | 70 | 12 | 110 |

The raw materials of the composition given above were mixed by using a Henschel mixer, followed by melting and kneading the mixture by using a biaxial extruder.

The molten and kneaded mixture thus obtained was cooled, followed by roughly pulverizing the cooled mixture in a hammer mill. Then, the roughly pulverized mixture was finely pulverized by using a jet pulverizer, followed by classifying the finely pulverized mixture so as to obtain toner particles having a volume average particle diameter of 9 μm.

Then, 0.5 part of a hydrophobic silica and 0.5 part of a hydrophobic titanium oxide were added to and mixed with 100 parts of the toner particles thus obtained by using a Henschel mixer so as to obtain a toner.

The toner thus obtained was tested and evaluated as follows. Table 2 shows the results.

Lowest Fixing Temperature:

The temperature at which at least 75% of the fixation remaining rate can be obtained was determined as the lowest fixing temperature.

Fixation Remaining Rate:

For determining the fixation remaining rate, a transfer paper sheet having a toner image transferred thereonto under the state that the set temperature of the heating roller included in the fixing device was successively elevated was subjected to a fixing treatment in the fixing device. The toner image was transferred onto the transfer paper sheet under a load of 400 N, a nip width of 7.5 mm and the fixing feeding rate of 200 mm/sec. The image concentration of the image section of the fixed image was measured and, after the image section was rubbed with a 100% cotton pad, the image concentration was measured again. The fixation remaining rate was obtained by the formula given below:

fixation remaining rate=image concentration after the rubbing/image concentration before the rubbing×100 (%)

Non-Offset Region:

For determining the non-offset region, the fixing treatment of the toner image to the transfer paper sheet was carried out under the conditions given above so as to observe whether or not the transfer paper sheet was stained with the toner. The fixing treatment was carried out under the state that the set temperature of the heating roller included in the fixing device was successively elevated. The temperature region within which any of the low temperature offset phenomenon, which takes place under a low temperature region, and the high temperature offset phenomenon, which takes place under a high temperature region, did not take place was determined as the non-offset region.

Smear Level:

For determining the smear level, samples showing 10 stages of the smear levels were prepared, and the smear level was determined on the basis of these samples. The smear level shown in Table 2 denotes the average value at the temperature falling within the non-offset region. The smaller evaluation value of the smear level represents the better result in terms of the smear, i.e., the cleaner surface of the transfer paper sheet.

Sticking Level:

For evaluating the sticking level, an image was consecutively printed on 800 recording paper sheets, and the printed recording paper sheets discharged from the printing apparatus were stacked one upon the other in a tray. The sticking level was evaluated by observing every 100 recording paper sheets a prescribed time later to see whether or not the image on the lower recording paper sheet was sticked to the back surface of the upper recording paper sheet.

The result of the evaluation is denoted by marks “\mathring{o}”, “◯”, “Δ” and “X” in Table 2. These marks denote:

\mathring{o}: Quite free from sticking;

◯: Substantially free from sticking;

Δ: Free from sticking. However, the adjacent recording paper sheets were stuck to each other, and sound was generated when the stuck paper sheets were peeled from each other;

X: Sticked image was clearly recognized.

Stains of Part:

For evaluating the stains of the part, the overall situation was observed in respect of the attachment of the contaminants such as the toner to the pressurizing roller, the fixation separating claw and the surface of the thermistor and the stains of the image on the front and back surfaces of the recording paper sheet after the printing on 100,000 recording paper sheets.

The result of the evaluation is denoted by marks “\mathring{o}”, “◯”, “Δ” and “X” in Table 2. These marks denote:

\mathring{o}: Free from attachment of contaminants to the pressurizing roller, etc., and free from stains of the image on the recording paper sheet;

◯: Substantially free from attachment of contaminants to the pressurizing roller, etc., and substantially free from stains of the image on the recording paper sheet;

Δ: Contaminants were attached to the pressurizing roller, etc. However, stains of the image on the recording paper sheet were not recognized;

X: Occurrence of an inconvenience such as attachment of a large amount of contaminants to the pressurizing roller, etc., the defect generation by the stains of the image, an abnormality generation in the temperature detected by the thermistor, or the jamming in the claw portion.

Storing Capability:

The toner in an amount of 20 g was put in a polyethylene bottle having an inner volume of 100 cc, and the bottle was kept immersed in a warm water of 55° C. for 8 hours. Then, the toner cooled to room temperature was taken out of the bottle and sieved for 30 seconds on a vibrating sieve of 60 meshes so as to weigh the residual toner on the sieve. The storing capability of the toner is satisfactory, if the residual amount of the toner on the sieve is not larger than 2 g.

Resistance to Blocking:

The toner in an amount of 20 g was put in a glass bottle having an inner volume of 100 mL, and the state of the toner was observed after the glass bottle was left to stand for 200 hours in an environmental vessel with the temperature set at 50° C. and the humidity set at 90%. The result of the evaluation is denoted by marks “◯”, “Δ” and “X” in Table 2. These marks denote:

◯: Quite free from blocking occurrence;

Δ: Soft caking state;

X: hard caking state.

TABLE 2

| | Lowest | | | | | | |
|---|---|---|---|---|---|---|---|
| | fixing | | | | | | Resistance |
| | temperature | Non-offset | Smear | Sticking | Stains | Storing | to |
| | (° C.) | range (° C.) | level | level | of part | capability | sticking |
| Example 1 | 125 | 120-190 | 3 | ⊚ | ⊚ | 1.52 | ◯ |
| Example 2 | 130 | 130-210 | 4 | ◯ | ◯ | 1.18 | ◯ |
| Example 3 | 135 | 135-210 | 3 | ⊚ | ◯ | 1.38 | ◯ |
| Example 4 | 130 | 125-210 | 3 | ◯ | ◯ | 1.49 | ◯ |
| Example 5 | 140 | 140-230 | 2 | ⊚ | ◯ | 1.46 | ◯ |
| Example 6 | 120 | 150-220 | 9 | X | X | 3.96 | X |
| Example 7 | 150 | 160-190 | 7 | ◯ | Δ | 2.78 | Δ |
| Comparative | 130 | 140-200 | 9 | X | Δ | 3.64 | X |
| Example 1 | | | | | | | |
| Comparative | 170 | 170-180 | 8 | ⊚ | Δ | 0.14 | ◯ |
| Example 2 | | | | | | | |

Examples 1 to 5 satisfied all the conditions (1) to (4) given below relating to the first to fourth aspects of the present invention:

(1) The temperature at the heat generation peak differs from the temperature at the heat absorption peak of the developing agent.

(2) The temperature at the DSC heat absorption peak of the developing agent in the heating step falls within the range of 100° C. to 135° C., the temperature at the DSC heat generation peak of the developing agent in the cooling step falls within the range of 70° C. to 120° C., and the ratio of the heat amount of the DSC heat absorption peak to the DSC heat generation peak falls within the range of 1 to 2.

(3) The rising temperature of the DSC heat absorption peak of the developing agent in the heating step falls within the range of the temperature at the DSC heat absorption peak to the temperature lower by 30° C. than the temperature at the DSC heat absorption peak, and the rising temperature of the DSC heat generation peak in the cooling step falls within the range of the temperature at the DSC heat generation peak to the temperature higher by 20° C. than the temperature at the DSC heat generation peak.

(4) The relationship given below between the temperature y of the DSC heat generation peak in the cooling step and the cooling rate x is satisfied:

y=−a×Ln(x)+b

0.5<a≦10, 60≦b≦100

The developing agent for each of Examples 1 to 5 was free from a problem in the lowest fixing temperature, broad in the non-offset region, and satisfactory in any of the smear level, the sticking level, the stains of the part, the storing capability, and the resistance to blocking. It has been found that, by using the developing agent satisfying conditions (1) to (4) given above, it is possible to ensure satisfactory fixing properties, to achieve improvements in each of the resistance to the offset phenomenon, the resistance to the smear, and the resistance to the sticking, to prevent the stains of the part and the winding about the part, and to form an image that can be kept clear over a long period of time.

Example 6 failed to satisfy condition (1) because the crystallinity exceeded 50%, failed to satisfy condition (2) because the temperature at the heat absorption peak was not higher than 100° C. and the ratio of the heat amount was not smaller than 2, and failed to satisfy condition (4) because the value of “a” was not smaller than 10 and the value of “b” was smaller than 60. Such being the situation, Example 6 was found to be inferior in all the evaluations to any of Examples 1 to 5.

Example 7 failed to satisfy condition (1) because the crystallinity was lower than 10%, failed to satisfy condition (2) because the temperature at the heat absorption peak was higher than 130° C. and the temperature at the heat generation peak was higher than 120° C., and failed to satisfy condition (4) because the value of “a” was smaller than 0.5 and the value of “b” exceeded 100° C. Such being the situation, Example 7 was found to be somewhat high in the lowest fixing temperature, to be somewhat narrow in the non-offset region, to bring about the smear generation to some extent, and to be somewhat low in the storing capability and the resistance to blocking compared with Examples 1 to 5, though the sticking level was not appreciably lowered and the stains of the part were not appreciably generated in Example 7.

Example 8 failed to satisfy condition (1) because the crystallinity was lower than 10%, failed to satisfy condition (2) because the temperature at the heat generation peak was lower than 70° C., failed to satisfy condition (3) because the difference between the rising temperature of the heat generation peak and the temperature at the heat generation peak exceeded 20° C., and failed to satisfy condition (4) because the value of “a” was smaller than 0.5 and the value of “b” was smaller than 60. Such being the situation, the developing agent for Example 8 was found to be somewhat inferior in all the evaluation items to the developing agent for each of Examples 1 to 5.

Example 9 failed to satisfy condition (1) because the crystallinity exceeded 50%, failed to satisfy condition (2) because the temperature at the heat absorption peak was higher than 130° C., the temperature at the heat generation peak was higher than 120° C., and the ratio of the heat amount exceeded 2, failed to satisfy condition (3) because the difference between the rising temperature of the heat absorption peak and the temperature at the heat absorption peak exceeded 30° C., and failed to satisfy condition (4) because the value of “a” was larger than 10 and the value of “b” was larger than 100. Such being the situation, the developing agent for Example 9 was found to be high in the lowest fixing temperature, to be narrow in the non-offset region, and to bring about smear and the stains of the part to some extent compared with the developing agent for each of Examples 1 to 5, though the offset was not generated in Example 9 and the developing agent for Example 9 was satisfactory in the storing capability and the resistance to the blocking.

As apparent from Examples 1 to 9, it is possible to obtain a developing agent in which the temperature at the DSC heat absorption peak in the heating step differs from the temperature at the DSC heat generation peak in the cooling step in the DSC curve measured by a differential thermal analysis apparatus, if a crystalline polyester is used as, for example, the binder resin.

It is also apparent from Examples 1 to 9 that any developing agent simply containing a crystalline resin is not necessarily satisfactory, and that the characteristics of the developing agent are changed by, for example, the properties of the crystalline resin such as the crystallinity and the properties of the developing agent such as the temperature at the DSC heat absorption peak, the temperature at the DSC heat generation peak, the ratio of the heat amount of the DSC heat absorption peak to the DSC heat generation peak, the rising temperature of the DSC heat absorption peak, the rising temperature of the DSC heat generation peak, and the relationship between the temperature at the DSC heat generation peak and the cooling rate. Further, it can be understood that a developing agent exhibiting satisfactory characteristics can be obtained if at least one of conditions (1) to (4) given above is satisfied, and that a developing agent exhibiting further excellent characteristics can be obtained if all of conditions (1) to (4) given above are satisfied.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising a binder resin containing a crystalline resin having a crystallinity of 10 to 50% and a coloring agent, wherein, in the DSC curve measured by a differential thermal analysis apparatus, the temperature at the DSC heat absorption peak in the heating step differs from the temperature at the DSC heat generation peak in the cooling step.

2. A developing agent according to claim 1, wherein the crystalline resin is a crystalline polyester resin.

3. A developing agent according to claim 1, further comprising a first wax having a melting point higher by at least 10° C. than the melting point of the crystalline resin and a second wax having a melting point lower by at least 10° C. than the melting point of the crystalline polyester resin.

4. A developing agent comprising a binder resin containing a crystalline resin and a coloring agent, wherein, in the DSC curve measured by a differential thermal analysis apparatus, the temperature at the DSC heat absorption peak in the heating step falls within the range of 100° C. to 130° C., the temperature at the DSC heat generation peak in the cooling step falls within the range of 70′ to 120° C., and a ratio in the heat amount of the DSC heat absorption peak to the DSC heat generation peak falls within the range of 1 to 2.

5. A developing agent according to claim 4, wherein the crystalline resin contains a crystalline resin having a crystallinity of 10 to 50%, and the temperature at the DSC heat absorption peak differs from the temperature at the DSC heat generation peak.

6. A developing agent according to claim 4, wherein the crystalline resin is a crystalline polyester resin.

7. A developing agent according to claim 4, further comprising a first wax having a melting point higher by at least 10° C. than the melting point of the crystalline resin and a second wax having a melting point lower by at least 10° C. than the melting point of the crystalline polyester resin.

8. A developing agent comprising a binder resin containing a crystalline resin and a coloring agent, wherein, in the DSC curve measured by a differential thermal analysis apparatus, the rising temperature of the DSC heat absorption peak in the heating step falls within the range of the temperature at the DSC heat absorption peak to the temperature lower by 30° C. than the temperature at the DSC heat absorption peak, and the rising temperature of the DSC heat generation peak in the cooling step falls within the range of the temperature at the DSC heat generation peak to the temperature higher by 20° C. than the temperature at the DSC heat generation peak.

9. A developing agent according to claim 8, wherein the temperature at the DSC heat absorption peak in the heating step falls within the range of 100° C. to 135° C., the temperature at the DSC heat generation peak in the cooling step falls within the range of 70° C. to 120° C., and the ratio of the heat amount of the DSC heat absorption peak to the DSC heat generation peak falls within the range of 1 to 2.

10. A developing agent according to claim 8, wherein the crystalline resin has a crystallinity of 10 to 50%, and the temperature at the DSC heat absorption peak differs from the temperature at the DSC heat generation peak.

11. A developing agent according to claim 8, wherein the crystalline resin is a crystalline polyester resin.

12. A developing agent according to claim 8, further comprising a first wax having a melting point higher by at least 10° C. than the melting point of the crystalline resin and a second wax having a melting point lower by at least 10° C. than the melting point of the crystalline resin.

13. A developing agent comprising a binder resin containing a crystalline resin and a coloring agent, wherein, in the DSC curve measured by a differential thermal analysis apparatus, the relationship given below is satisfied between the temperature y of the DSC heat generation peak in the cooling step and the cooling rate x:
y=−a×Ln(x)+b
0.5≦a≦—10, 60≦b≦100

14. A developing agent according to claim 13, wherein the rising temperature of the DSC heat absorption peak in the heating step falls within the range of the temperature at the DSC heat absorption peak to the temperature lower by 30° C. than the temperature at the DSC heat absorption peak, and the rising temperature of the DSC heat generation peak in the cooling step falls within the range of the temperature at the DSC heat generation peak to the temperature higher by 20° C. than the temperature at the DSC heat generation peak.

15. A developing agent according to claim 13, wherein the temperature at the DSC heat absorption peak in the heating step falls within the range of 100° C. to 135° C., the temperature at the DSC heat generation peak in the cooling step falls within the range of 70° C. to 120° C., and the ratio of the heat amount of the DSC heat absorption peak to the DSC heat generation peak falls within the range of 1 to 2.

16. A developing agent according to claim 13, wherein the crystalline resin has a crystallinity of 10 to 50%, and the temperature at the DSC heat absorption peak differs from the temperature at the DSC heat generation peak.

17. A developing agent according to claim 13, wherein the crystalline resin is a crystalline polyester resin.

18. A developing agent according to claim 13, further comprising a first wax having a melting point higher by at least 10° C. than the melting point of the crystalline resin and a second wax having a melting point lower by at least 10° C. than the melting point of the crystalline resin.
